(19) United States
(12) Patent Application Publication
(10) Pub. No.: US 2016/0050717 A1
(43) Pub. Date: Feb. 18, 2016

(54) INFRARED EMITTER

(71) Applicant: National Taiwan University, Taipei (TW)

(72) Inventors: Si-Chen Lee, Taipei (TW); Hung-Hsin Chen, Taipei (TW); Shi-Ming Lin, Taipei (TW)

(21) Appl. No.: 14/560,107

(22) Filed: Dec. 4, 2014

(30) Foreign Application Priority Data
Aug. 14, 2014 (TW) 103214469

(51) Int. Cl. H05B 3/00; H05B 3/12; H05B 3/14; H05B 1/02

(52) U.S. Cl. CPC H05B 3/0014; H05B 1/0288; H05B 3/12; H05B 3/141; H05B 3/14

(57) ABSTRACT

An infrared emitter is provided, including a battery; a carrier having a groove formed in a center thereof and a plurality of holes formed through the carrier via the groove; a resistive fuse penetrating the holes and wound around the carrier, and having two ends electrically connected to negative and positive electrodes of the battery, respectively; and an infrared chip disposed in the groove of the carrier and being in direct contact with the resistive fuse, wherein heat is generated when a current of the battery flows through the resistive fuse so that the carrier and the infrared chip can be heated to enable the infrared chip to emit infrared rays. Accordingly, the infrared emitter has the advantages of small-size, light-weight and simple structure and great portability to significantly increase the convenience in use, especially in the application of narrow bandwidth infrared radiation relevant researches on biological cells.

### BACKGROUND OF THE INVENTION

1. Field of the Invention

The present invention relates to infrared emitters, and, more particularly, to a portable narrow bandwidth infrared emitter.

2. Description of Related Art

Infrared ray is a type of light, and is a type of electromagnetic waves. It could be absorbed by organism cells, to enable the organism to sense the existence of the infrared ray by the way of making it feel the “heat.” The absorbed infrared ray energy can increase the temperature of the local organization of the organisms, so that it can make the blood capillary expand and promote the blood circulation of the organism. This is to slow muscle aches, increase the body immunity, balance body pH, and achieve other medical efficacy. Thus, the function of the infrared light is often applied to the medical care or treatment products, such as infrared lamps on care.

The infrared light source of general infrared lamps on care uses the halogen bulb, or uses the way of heating the ceramic material coated with a far infrared coating to produce the infrared light with the range of 3-25 micron wavelength. However, the power consumption of these products is usually large and must be used with a large volume of power supply to stabilize the power supply. This results in a huge volume of a whole, and thus has the disadvantage of products unable to be carried. So these products are more inconvenient. Moreover, not all the infrared light wavelength range has been effective to the organism. Research about infrared light with specific wavelengths is also more and more attention. Due to the current infrared light emitted by those infrared lamps on care is more for broadband infrared, and in order to obtain infrared light with specific wavelength to improve the efficiency of the treatment, the infrared lamps on care tend to be fitted with narrowband filters. However, this will make the device much larger volume again.

Therefore, the topic about the followings is currently one of the topics to be solved: how to provide a portable infrared emitter, how to emit infrared light with narrow bandwidth, how to improve the existing infrared lamp on care with a problem of the bulky inconvenience to use, how to focus and emit infrared light with useful wavelength range, and how to improve the efficiency of the infrared emission.

### SUMMARY OF THE INVENTION

To solve the problems of the prior art, the present invention provides an infrared emitter, including a battery; a carrier having a groove formed in a center thereof and a plurality of holes formed through the carrier via the groove; a resistive fuse penetrating the holes and wound around the carrier, and having two ends electrically connected to negative and positive electrodes of the battery, respectively; and an infrared chip disposed in the groove of the carrier and being in direct contact with the resistive fuse; wherein heat is generated when a current of the battery flows through the resistive fuse so that the carrier and the infrared chip can be heated to enable the infrared chip to emit infrared rays.

Accordingly, heat is generated when the electric DC of the battery flows through the resistive fuse so that the infrared chip can be heated to enable the infrared chip to emit the infrared ray with a specific narrowband wavelength. The infrared emitter of the creation has the advantages of small-size, light-weight and simple structure and great portability to significantly increase the convenience in use, especially in the application of narrow bandwidth infrared radiation relevant researches on biological cells.

### BRIEF DESCRIPTION OF DRAWINGS

The invention can be more fully understood by reading the following detailed description of the preferred embodiments, with reference made to the accompanying drawings, wherein:

FIG. 1 illustrates the schematic diagram for the constitution of a carrier of an infrared emitter according to the present invention;

FIG. 2 is a schematic diagram showing a cross-section of the carrier shown on the FIG. 1; and

FIG. 3 illustrates the schematic diagram for the whole constitution of the infrared emitter according to the present invention.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

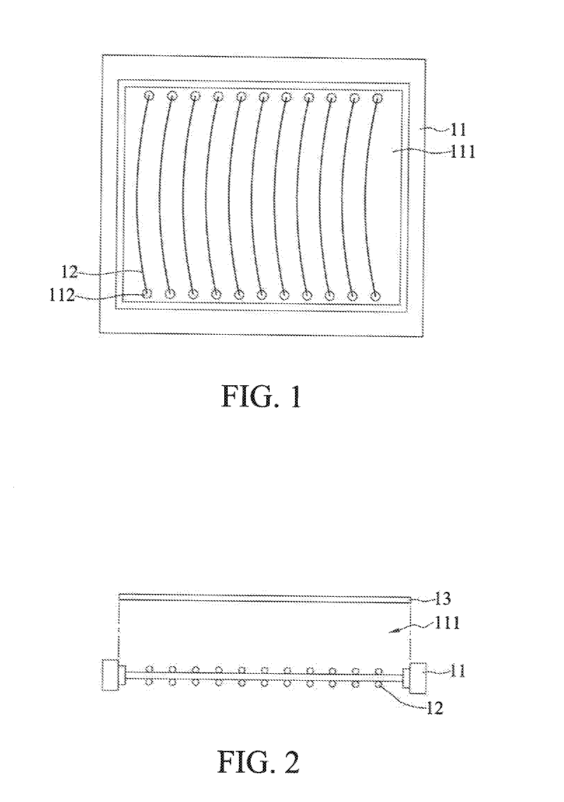

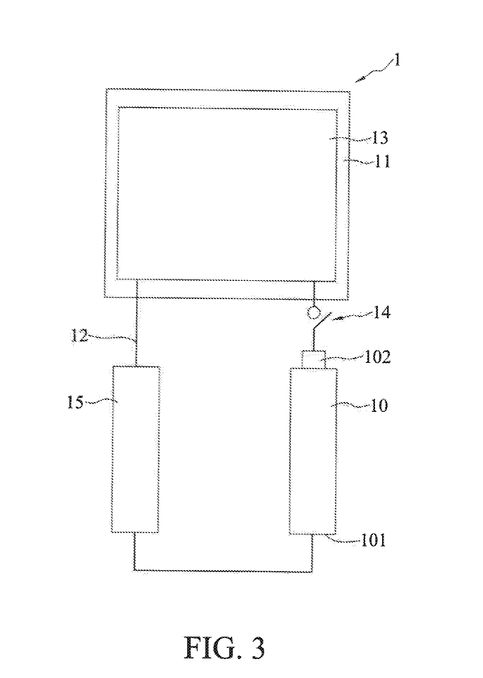

In regard to FIG. 3, it is a schematic diagram of an infrared emitter according to the present invention. The infrared emitter 1 includes a battery 10, a carrier 11, a resistive fuse 12, and an infrared chip 13. FIG. 1 and FIG. 2 show detailed illustration of the structure composed of the carrier 11, the resistive fuse 12, and the infrared chip 13. As shown in FIG. 1, a carrier 11 has a groove 111 formed in a center thereof and a plurality of holes 112 are formed through the carrier 11 via the groove 111. A resistive fuse 12 penetrates the holes 112 sequentially to be wound around the carrier 11. In an embodiment, the holes 112 are formed adjacent to the edge of groove 111. As shown in FIG. 1, the holes 112 are formed along two edges of the groove 111. This is to make the resistive fuse 12 penetrate the drilled hole 112 on one side, and then wind to the other side to penetrate the drilled hole 112 there, in order to make the resistive fuse 12 be wound back on the way to and from a second end disposed on the carrier 11. Such a winding method allows the resistive fuse 12 to be simultaneously exposed on two surfaces of the carrier 11, as shown in FIG. 2. However, the present invention is not limited to the winding manner for the resistive fuse 12, nor is limited to the positions of the holes 112. In another embodiment, the resistive fuse 12 is a nickel-chromium alloy fuse or a metal wire. The metal wire can have a high resistance value and the thin property. For example, the size of the carrier 11 may be 14 mm×14 mm, and the diameter of the resistive fuse is 0.4 mm But the present invention is not limited thereto.

The infrared chip 13 is disposed on a surface of the carrier 11. As shown in FIG. 2, the infrared chip 13 is provided in the groove 111 of the carrier 11. Because the groove 111 has a resistive fuse 12 wound, when the infrared chip 13 is provided in the groove 111 of the carrier 11, the chip 13 directly contacts with the resistive fuse 12. The infrared chip 13 can be put in the groove 111 of the carrier 11 by heat-resistant adhesive glue or by a mechanical way, e.g., latching engagement, directly making the resistive fuse 12 be wound around the infrared chip fixed in the grooves 111 of the carrier 11. Those mechanical ways are by locks with screws. But the methods are not limited to the above. The resistive fuse 12 is wound around the carrier 11. Moreover, portions of the resistive fuse 12 are exposed from the carrier 11. The resistive fuse 12 has one end electrically connected to the negative electrode 101 of the battery 10, and the other end connected with the positive electrode 102 of the battery 10. This is to complete the formation of a pathway. Accordingly, heat is generated when the current of the battery 10 flows through the resistive fuse 12. Owing to the fact that the resistive fuse 12 is wound around the carrier 11, the heat energy generated by the resistive fuse 12 is used to heat the carrier 11 in order to increase the temperature of the carrier 11. Besides, the resistive fuse 12 directly contacts with the infrared chip 13. The heat energy generated by the resistive fuse 12 can make the infrared chip 13 be heated to increase the temperature of the infrared chip 13. Owing to the fact that the direct contact makes the heat conduction to the infrared chip 13 directly from the resistive fuse 12, energy would not lose so the efficiency of emitting infrared rays could be increased. The infrared chip 13, after heated, can emit the infrared rays. The wavelength of infrared rays emitted from the infrared chip 13 is in a range of 2-20 microns. A full width at half maximum (FWHM) is in a range of 0.1-2 microns. In an embodiment, the wavelength of infrared rays emitted from the infrared chip 13 is 5.2 microns, and the FWHM is 0.2 micron, but the present invention is not limited thereto. Besides the single wavelength infrared emission chip, the multi-wavelengths infrared emission chip can be also applied into this invention. Indeed, the portable infrared emitter with multi-wavelengths (more than two wavelengths) infrared emission was realized, but the present invention is not limited thereto. In another embodiment, the carrier 11 is made of the heat-resistant material, such as Teflon, ceramic glass, ceramics or quartz, and the least thickness is up to 0.1 mm, but the present invention is not limited thereto. In addition, the carrier 11 could not only use one edge thereof to fit the infrared chip 13. The carrier 11 could use two edges thereof to fit the infrared chips 13. In other words, two edges of the carrier 11 have the grooves 111 in order to accommodate different infrared chips 13. The present invention about the infrared chip set does not limit the number of infrared chips 13.

The infrared emitter 1 according to the present invention includes an on/off switch 14 disposed on the circuit on which the resistive fuse 12 is disposed between the battery 10 and the carrier 11. One end of the on/off switch 14 is electrically connected to the positive electrode 102 of the battery 10 while the other end of the on/off switch 14 is connected to the resistive fuse 12. The on/off switch 14 can control the current of the battery showing either “ON” of the ON state or “OFF” of the short-circuit state. Moreover, the infrared emitter 1 includes resistor 15. The resistor 15 is disposed on the circuit on which the resistive fuse 12 is disposed between the negative electrode 101 of the battery 10 and the carrier 11. The resistor 15 controls the value of the current of the battery 10. Namely, the resistor 15 can be replaced by another resistor with a different resistance value, if necessary. In an embodiment, the resistor may be that with a fixed resistance value or with a variable resistance value, but it is not limited thereto. In addition to using the resistor 15 to control the value of current of the battery 10, a circuit for controlling current can be used to adjust the input current and further to control the temperature of the carrier 11 and the infrared chip 13. The infrared emitter 1 according to the present invention can further include a housing. The housing is divided into two parts, an upper lid and a lower lid. A hollow rectangular parallelepiped can house the battery 10, the carrier 11, the resistive fuse 12, the infrared chip 13, the on/off switch 14, the resistor 15 and other components. In an embodiment, the housing is made of hard material such as plastics, metal, ceramics or Teflon, but it is not limited thereto. An opening having an appropriate size can be formed on a surface side of the housing corresponding to the infrared chip 13, in order to make the infrared rays emitted by the infrared chip 13 transmit and emit from the opening. The size of the housing can be 2.5×5×12 cm³, and the size of the opening is about 1 cm². The opening may be attached by a protective slice made of calcium fluoride (CaF₂) in order to prevent users from accidentally coming into contact with the heated infrared chip 13. The protective slice may also be made of potassium bromide (KBr), silicon (Si) or germanium (Ge), etc whose material has the infrared transmission property. But it is not limited thereto.

In summary, the present invention uses the small plastic housing to accommodate the battery, the carrier, the resistive fuse, and the infrared chips forms the infrared emitter. As well, the direct current supplied by the battery makes the resistive fuse directly heat the infrared chip, and so the infrared chip is capable of emitting the narrowband infrared light with a specific wavelength. Hence, the infrared emitter of the creation has the advantages of small-size, light-weight and simple structure and great portability. It can also improve the efficiency of the infrared emission. It can significantly increase the convenience in use especially in the application of narrow bandwidth infrared radiation relevant researches on biological cells. It is to improve the existing infrared lamp on care with a problem of the bulky inconvenience to use.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. An infrared emitter, comprising:
a battery;
a carrier having a groove formed in a center thereof and a plurality of holes formed through the carrier via the groove;
a resistive fuse penetrating the holes and wound around the carrier, and having two ends electrically connected to negative and positive electrodes of the battery, respectively; and
an infrared chip disposed in the groove of the carrier and directly contacting with the resistive fuse;
wherein heat is generated when a current of the battery flows through the resistive fuse so that the carrier and the infrared chip can be heated to enable the infrared chip to emit infrared rays.

2. The infrared emitter according to claim 1, wherein the resistive fuse is a nickel-chromium alloy fuse or a metal fuse.

3. The infrared emitter according to claim 1, wherein the carrier is made of Teflon, ceramic glass, ceramics, quartz or other heat-resistant material.

4. The infrared emitter according to claim 1, further comprising an on/off switch that has two ends connected to the positive and negative electrodes of the battery, respectively, to control a flowing of the current of the battery.

5. The infrared emitter according to claim 1, wherein the infrared chip is disposed in the groove of the carrier by heat-resistant adhesive glue or by a mechanical way.

6. The infrared emitter according to claim 1, wherein infrared rays emitted from the infrared chip has wavelength in a range of 2-20 microns, and a full width at half maximum in a range of 0.1-2 microns.

7. The infrared emitter according to claim 1, further comprising a housing for receiving the battery, the carrier, the resistive fuse, and the infrared chip, the housing being made of plastics, metal, ceramics, Teflon, or other hard material.

8. The infrared emitter according to claim 7, wherein the housing has an opening formed on a surface side thereof corresponding to the infrared chip, and a protective member attached to the opening and made of calcium fluoride (CaF₂), potassium bromide (KBr), silicon (Si) or germanium (Ge).

9. The infrared emitter according to claim 1, further comprising a resistor or a circuit disposed between the negative electrode of the battery and the resistive fuse to control a value of the current of the battery.
